(19) United States
(12) Patent Application Publication
(10) Pub. No.: US 2016/0320818 A1
(43) Pub. Date: Nov. 3, 2016

(54) DYNAMIC MANAGEMENT OF POWER SUPPLY UNITS

(71) Applicant: Quanta Computer Inc., Taoyuan City (TW)

(72) Inventors: Jen-Hsuen HUANG, Taoyuan City (TW); Fa-Da LIN, Taoyuan City (TW); Kengyu LIN, Taoyuan City (TW)

(21) Appl. No.: 14/698,221

(22) Filed: Apr. 28, 2015

(51) Int. Cl. G06F 1/26; G06N 99/00

(52) U.S. Cl. CPC G06F 1/266; G06N 99/005

(57) ABSTRACT

Various embodiments of the present technology provide methods for managing two or more PSUs of a server system according to one or more PSU management algorithms. Some embodiments determine present and/or predicted loading of a server system and loading of each of the two or more PSUs of the server system. A first subset of the two or more PSUs can be turned off based at least upon the current and/or predicted loadings of the server system and the loading of the two or more PSUs. The current loading of the server system can be rebalanced among a second subset of the two or more PSUs that are in operation. One or more PSUs in the first subset and the second subset of the two or more PSUs can be periodically swapped according to the one or more PSU management algorithms.

### TECHNICAL FIELD

The present technology relates generally to server systems in a telecommunications network.

### BACKGROUND

Modern server farms or datacenters typically employ a large number of servers to handle processing needs for a variety of application services. Each server handles various operations and requires a certain level of power consumption to maintain these operations. Some of these operations are “mission critical” operations, interruptions to which may lead to significant security breach or revenue losses for users associated with these operations.

One source of interruptions is failures or faults at power supply units (PSUs) to a server system. A failure or a fault in one or more PSUs can force a sudden shutdown of a server system, possibly resulting in data losses or even damage to the server system. Typically, server systems contain one or more redundant PSUs that provide power to loads of the server systems. Therefore, when one power supply unit fails, the other PSUs can continue to provide power to the loads. However, there are many inherent problems associated with using redundant power supply units.

### SUMMARY

Systems and methods in accordance with various embodiments of the present technology provide a solution to the above-mentioned problems by dynamically managing two or more power supply units (PSUs) in a server system such that PSUs of the server system can operate at a substantially optimized efficiency level and having substantially optimized mean time between failures (MTBFs). More specifically, various embodiments of the present technology provide methods for managing two or more PSUs of a server system according to one or more PSU management algorithms. Some embodiments determine present and/or predicted loading of a server system and loading of each of the two or more PSUs of the server system. A first subset of the two or more PSUs can be turned off based at least upon the current and/or predicted loadings of the server system and the loading of the two or more PSUs. The current loading of the server system can be rebalanced among a second subset of the two or more PSUs that are in operation. One or more PSUs in the first subset and the second subset of the two or more PSUs can be periodically swapped according to the one or more PSU management algorithms.

In some implementations, current loading of a server system can be rebalanced among a second subset of two or more PSUs such that PSUs in the second subset operate substantially at an optimized efficiency level. For instances, each of PSUs in the subset can be loaded to approximately a predetermined percentage (e.g., 50%) of its maximum rated current.

In some embodiments, a loading balancing algorithm can be used to rebalance the current loading of the server system among PSUs in a second subset of the two or more PSUs that are in operation, or swapping at least one PSU between the first subset and the second subset of the two or more PSUs. A determination to rebalance the current loading of the server system or swap the at least one PSU between the first subset and the second subset can be based at least upon a predetermined minimum load, a predetermined maximum load, or a predetermined minimum efficiency.

In some embodiments, in response to a loading of a server system being increased above a threshold high value, all PSU(s) in the first subset of the two or more PSUs can be merged into the second subset of the two or more PSUs. In other words, all of the two or more PSUs in the server system are turned on and in operation.

Some implementations can collect historical loading information of a server system. The collected historical loading information can be analyzed according to one or more machine learning algorithms and used to predict a loading pattern of the server system at a specific future time. A first subset of the two or more PSUs can be determined based at least upon current and predicted loadings of the server system or loading of two or more PSUs of the server system. In some implementations, other information associated with the server system can also be collected and used to predict loading of the server system. The other information includes, but is not limited to, health of each of the two or more PSUs, other server systems, time of day, day of a year, temperature, cooling fan speeds, power status, memory and operating system (OS) status, various data packet arrival rates, and data queue statistics etc. In some implementations, historical data regarding loading and efficiency of each of the two or more PSUs can be collected and used to dynamically assign PSUs in and out of the first subset and the second subset of PSUs. For example, a particular PSU, that has been used least frequently among the two or more PSUs or has a higher operating efficiency than an average efficiency of the two or more PSUs, can be assigned to the second subset more frequently.

In some implementations, the one or more PSU management algorithms can include at least one machine learning algorithm. Collected information associated with a server system can serve as an input feature set for the at least one machine learning algorithm to predict a loading pattern of the server system. The one or more machine learning algorithms may include, but are not limited to, at least one of linear regression model, neural network model, support vector machine based model, Bayesian statistics, case-based reasoning, decision trees, inductive logic programming, Gaussian process regression, group method of data handling, learning automata, random forests, ensembles of classifiers, ordinal classification, or conditional random fields.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only example aspects of the disclosure and are not therefore to be considered to be limiting of its scope, the principles herein are described and explained with additional specificity and detail through the use of the accompanying drawings in which:

FIG. 1 illustrates a schematic block diagram of an exemplary server system in accordance with an implementation of the present technology;

FIGS. 2A-2G illustrate examples of a first subset of two or more PSUs that are turned off and a second subset of the two or more PSUs that are in operation in accordance with implementations of the present technology;

FIGS. 3A-3B illustrate another examples of a first subset of two or more PSUs that are turned off and a second subset of the two or more PSUs that are in operation in accordance with implementations of the present technology;

FIG. 4 illustrates an exemplary method of managing power supply units of a server system in accordance with an implementation of the present technology;

FIG. 5 illustrates an exemplary computing device in accordance with various implementations of the technology; and

FIGS. 6A and 6B illustrate exemplary systems in accordance with various embodiments of the present technology.

### DETAILED DESCRIPTION

Various embodiments of the present technology provide methods for managing two or more PSUs in a server system to achieve substantially optimized power efficiency and MTBFs of PSUs. In some implementations, present and/or predicted loading of a server system and loading of each of the two or more PSUs of the server system can be determined by using one or more PSU management algorithms. A first subset of PSUs can be turned off based upon at least upon determined loading information of the server system and the two or more PSUs. The current loading of the server system can be rebalanced among a second subset of the two or more PSUs (i.e., the remaining PSUs that are in operation). PSUs in the first subset and the second subset can be periodically swapped according to the PSU management algorithm.

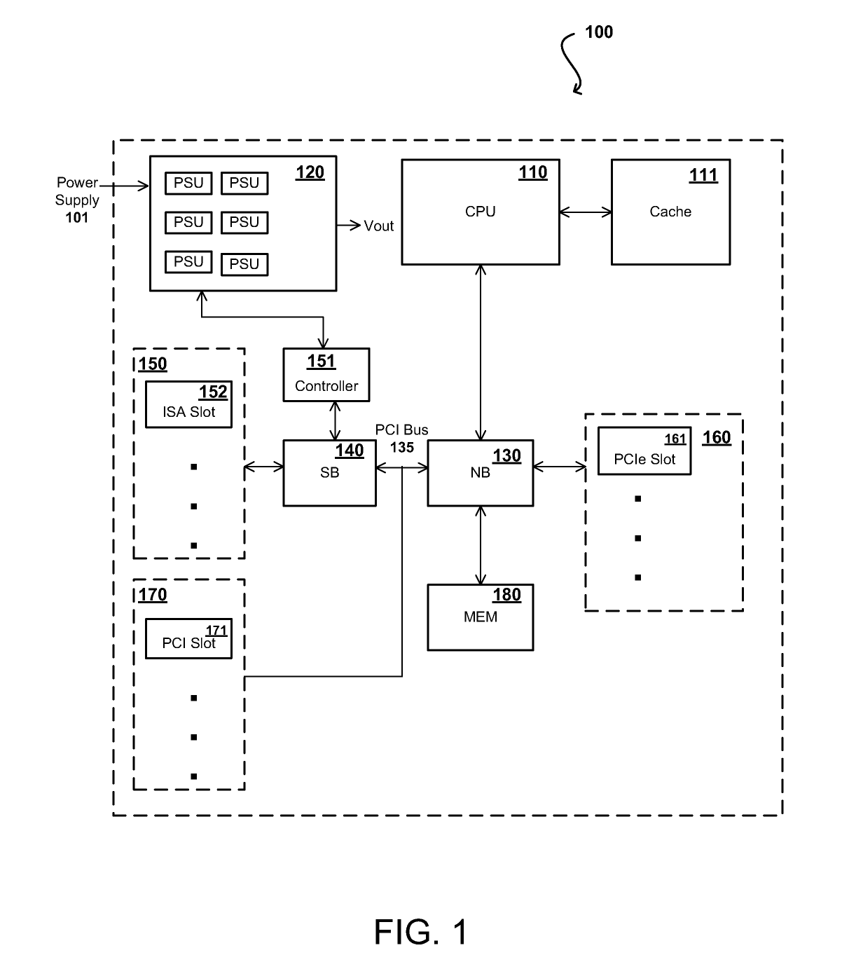

FIG. 1 illustrates a schematic block diagram of an exemplary server system 100 in accordance with an implementation of the present technology. In this example, the server system 100 comprises at least one microprocessor or CPU 110 connected to a cache 111, a main memory 180, and two or more PSUs 120 that provides power to the server system 100. The main memory 180 can be coupled to the CPU 110 via a north bridge (NB) logic 130. A memory control module (not shown) can be used to control operations of the memory 180 by asserting necessary control signals during memory operations. The main memory 180 may include, but is not limited to, dynamic random access memory (DRAM), double data rate DRAM (DDR DRAM), static RAM (SRAM), or other types of suitable memory.

In some implementations, the CPU 110 can be multi-core processors, each of which is coupled together through a CPU bus connected to the NB logic 130. In some implementations, the NB logic 130 can be integrated into the CPU 110. The NB logic 130 can also be connected to a plurality of peripheral component interconnect express (PCIe) ports 160 and a south bridge (SB) logic 140. The plurality of PCIe ports 160 can be used for connections and buses such as PCI Express x1, USB 2.0, SMBus, SIM card, future extension for another PCIe lane, 1.5 V and 3.3 V power, and wires to diagnostics LEDs on the server's chassis.

In this example, the NB logic 130 and the SB logic 140 are connected by a peripheral component interconnect (PCI) Bus 135. The PCI Bus 135 can support function on the CPU 110 but in a standardized format that is independent of any of CPU's native buses. The PCI Bus 135 can be further connected to a plurality of PCI slots 170 (e.g., a PCI slot 171). Devices connect to the PCI Bus 135 may appear to a bus controller (not shown) to be connected directly to a CPU bus, assigned addresses in the CPU 110's address space, and synchronized to a single bus clock. PCI cards can be used in the plurality of PCI slots 170 include, but are not limited to, network interface cards (NICs), sound cards, modems, TV tuner cards, disk controllers, video cards, small computer system interface (SCSI) adapters, and personal computer memory card international association (PCMCIA) cards.

The SB logic 140 can couple the PCI bus 135 to a plurality of expansion cards or slots 150 (e.g., an ISA slot 152) via an expansion bus. The expansion bus can be a bus used for communications between the SB logic 140 and peripheral devices, and may include, but is not limited to, an industry standard architecture (ISA) bus, PC/104 bus, low pin count bus, extended ISA (EISA) bus, universal serial bus (USB), integrated drive electronics (IDE) bus, or any other suitable bus that can be used for data communications for peripheral devices.

In the example, the SB logic 140 is further coupled to a controller 151 that is connected to the two or more PSUs 120. The two or more PSUs 120 are configured to supply powers to various component of the server system 100, such as the CPU 110, cache 111, NB logic 130, PCIe slots 160, Memory 180, SB logic 140, ISA slots 150, PCI slots 170, and controller 151. After being powered on, the server system 100 is configured to load software application from memory, computer storage device, or an external storage device to perform various operations. The server system 100 can also include a battery system (not shown) to supply power to the server system 100 when the power supply 101 is interrupted. The two or more PSUs 120 can include one or more rechargeable battery cells. The one or more rechargeable battery cells may include, but are not limited to, an electrochemical cell, fuel cell, or ultra-capacitor. The electrochemical cell may include one or more chemicals from a list of lead-acid, nickel cadmium (NiCd), nickel metal hydride (NiMH), lithium ion (Li-ion), and lithium ion polymer (Li-ion polymer). In a charging mode, the one or more rechargeable battery cells can be charged by the PSU 120.

In some implementations, the controller 151 can be a baseboard management controller (BMC), rack management controller (RMC), a keyboard controller, or any other suitable type of system controller. The controller 151 is configured to control operations of the two or more PSUs 120 and/or other applicable operations.

Some implementations enable the controller 151 to collect loading information of the server system 100 and the two or more PSUs 120. In some implementations, historical loading information of the server system 100 within one or more predetermined time windows is also collected. As used herein with respect to a server system or portions thereof, the term “load” or “loading” refers to the amount of computational work that the server system (or portions thereof) is performing or is expected to perform at a time of interest. Collected present and/or historical loading information can be analyzed and used to determine a first subset of PSUs to be turned off according to one or more PSU management algorithms. In some embodiments, the one or more PSU management algorithms can further include at least one machine more machine learning algorithm that includes linear regression model, neural network model, support vector machine based model, Bayesian statistics, case-based reasoning, decision trees, inductive logic programming, Gaussian process regression, group method of data handling, learning automata, random forests, ensembles of classifiers, ordinal classification, or conditional random field. For example, a neural network model can be used to analyze historical loading information and to capture complex correlation between time and loading patterns of the server system 100.

In some implementations, loading information of other server systems can also be collected and stored in a local or remote data storage that is associated with the server system 100. The loading information of other server systems can also be analyzed to predict a loading pattern of the server system 100 and used to determine a first subset of PSUs to be turned off according to the one or more PSU management algorithms.

In some implementations, the controller 151 can collect parameters (e.g., temperature, cooling fan speeds, power status, memory and/or operating system (OS) status) from different types of sensors that are built into the server system 100. In some implementations, the controller 151 can also collect other information, which includes, but is not limited to, health of each of the two or more PSUs 120, time of day, day of a year, various data packet arrival rates, and data queue statistics etc. Collected parameter information can also be analyzed and used to determine a loading pattern of the server system 100 and used to determine a first subset of PSUs to be turned off. In some implementations, historical data regarding loading and efficiency of each of the two or more PSUs can also be collected and used to dynamically assign PSUs in and out of the first subset and the second subset of PSUs. For example, a particular PSU, that has been used most frequently in the past or has a lower operating efficiency than an average efficiency of the two or more PSUs, can be assigned to the first subset more frequently.

Some implementations rebalance current loading of the server system 100 among a second subset of the two or more PSUs 120 such that at least one of PSUs in the second subset operates at a substantially optimized efficiency level. Therefore, energy efficiencies of the two or more PSUs 120 in the server system 100 can be substantially optimized by operating a second subset of the two or more PSUs 120 at substantially optimized efficiency levels and turning off the remaining PSUs.

In some implementations, one or more PSUs in the first subset and the second subset of the two or more PSUs can be periodically swapped according to one or more PSU management algorithms such that overall MTBFs of the two or more PSUs 120 can be substantially optimized. For example, a life time of a specific PSU in the server system 100 can be extended by periodically swapping the specific PSU to the first subset of the two or more PSUs 120. The specific PSU can rest for a specific time period T before being switched back to operation, which effectively results in an optimized overall MTBF of the two or more PSUs 120.

In some implementations, the controller 151 can also be configured to take appropriate action when necessary. For example, in response to any parameter on the different types of sensors that are built into the server system 100 going beyond preset limits, which can indicate a potential failure of the server system 100, the controller 151 can be configured to perform a suitable operation in response to the potential failure. The suitable operation can include, but is not limited to, sending an alert to the CPU 110 or a system administrator over a network, or taking some corrective action such as resetting or power cycling the node to get a hung OS running again).

Although only certain components are shown within the server system 100 in FIG. 1, various types of electronic or computing components that are capable of processing or storing data, or receiving or transmitting signals can also be included in server system 100. Further, the electronic or computing components in the server system 100 can be configured to execute various types of application and/or can use various types of operating systems. These operating systems can include, but are not limited to, Android, Berkeley Software Distribution (BSD), iPhone OS (iOS), Linux, OS X, Unix-like Real-time Operating System (e.g., QNX), Microsoft Windows, Window Phone, and IBM z/OS.

Depending on the desired implementation for the server system 100, a variety of networking and messaging protocols can be used, including but not limited to TCP/IP, open systems interconnection (OSI), file transfer protocol (FTP), universal plug and play (UpnP), network file system (NFS), common internet file system (CIFS), AppleTalk etc. As would be appreciated by those skilled in the art, the server system 100 illustrated in FIG. 1 is used for purposes of explanation. Therefore, a network system can be implemented with many variations, as appropriate, yet still provide a configuration of network platform in accordance with various embodiments of the present technology.

In exemplary configuration of FIG. 1, the server system 100 can also include one or more wireless components operable to communicate with one or more electronic devices within a computing range of the particular wireless channel. The wireless channel can be any appropriate channel used to enable devices to communicate wirelessly, such as Bluetooth, cellular, NFC, or Wi-Fi channels. It should be understood that the device can have one or more conventional wired communications connections, as known in the art. Various other elements and/or combinations are possible as well within the scope of various embodiments.

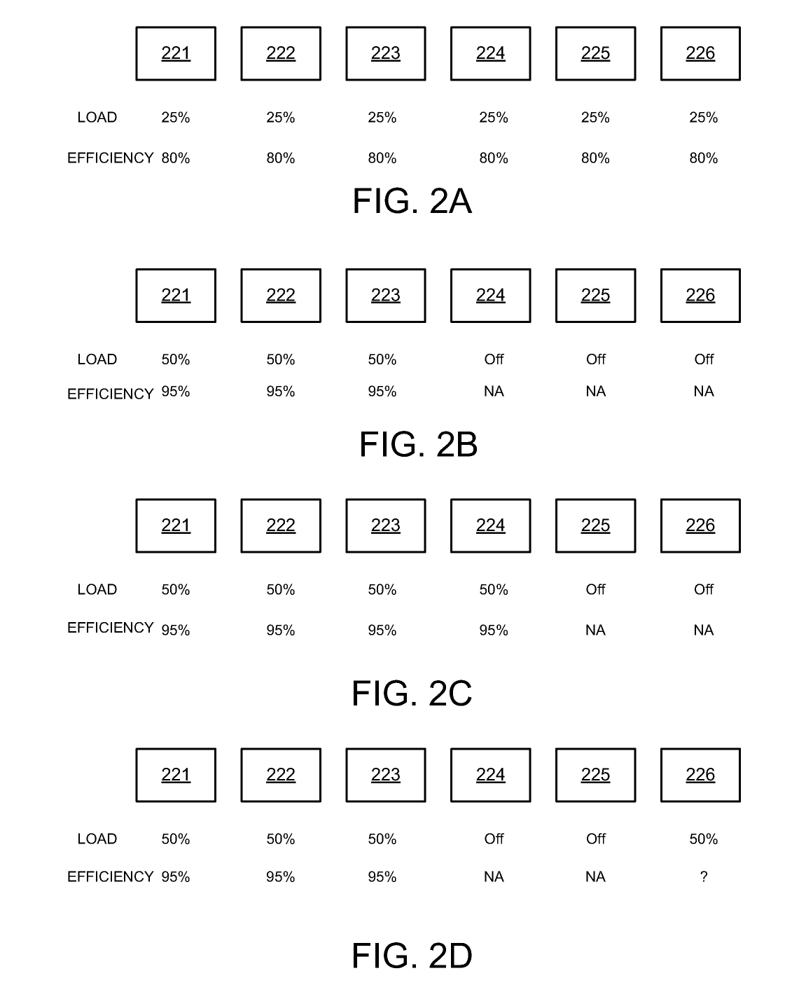

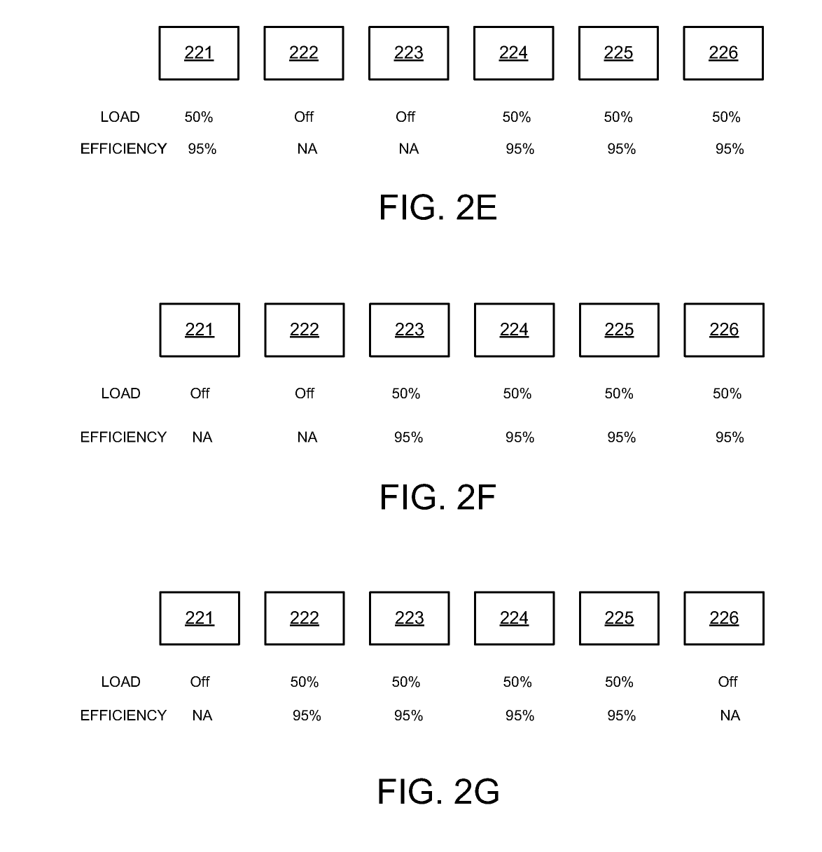

FIGS. 2A-2G illustrate examples of a first subset of two or more PSUs that are turned off and a second subset of the two or more PSUs that are in operation in accordance with implementations of the present technology. FIG. 2A illustrates a scenario when a server system operates in a light load condition. In this example, there are a total of six PSUs in the sever system. Each of the six PSUs (i.e., 221, 222, 223, 224, 225 and 226) operates with only a 25% load and has a lower operating efficiency than operating efficiencies with an optimized load (e.g., 50%). One of ordinary skilled in the art will appreciate that loads and efficiencies in FIGS. 2A-2G are for illustration purpose only. Various embodiments of the present technology apply to different loads and efficiencies or correlations between loads and efficiencies.

A controller of the server system can collect present and/historical loading of the server system and loading of six PSUs in the server system. The controller can further analyze the loading information to predict a loading pattern of the server system and to determine a first subset of PSUs to be turned off according to one or more PSU management algorithms. Let's assume that each of six PSUs reaches an optimized efficiency level when a corresponding PSU operates at a 50% load. FIG. 2B illustrates an example of a first subset of PSUs that are turned off and a second subset of PSUs that are in operation. In this example, the first subset of PSUs includes PSUs 224, 225 and 226, and the second subset of PSUs includes 221, 222 and 223. The PSUs in the second subset operate at a substantially optimized efficiency level (i.e., 50%) while the PSUs in the first subset are turned off.

In some implementations, a controller of the server system can compare the loading of PSUs in the server system with a predetermined low threshold value (e.g., 30%). In response to determining that two or more PSUs operate with a load lower than the low threshold value, the controller can turn off one of the two or more PSUs and include the corresponding PSU in the first subset of PSUs that are turned off.

FIGS. 2C-2G illustrate examples of periodically swapping one or more PSUs between a first subset of six PSUs that are turned off and a second subset of six PSUs that are in operation in accordance with an implementation of the present technology. FIG. 2C illustrates an example of a first subset of PSUs (i.e., 225 and 226) that are turned off and a second subset of PSUs (i.e., 221, 222, 223 and 224) that are in operation. In this example, the PSUs in the second subset operates at a substantially optimized efficiency level (i.e., 50%) while the PSUs in the first subset are turned off.

FIG. 2D-2G illustrate examples of periodically swapping one or more PSUs between the first subset of PSUs and the second subset of PSUs in FIG. 2C. As illustrated in FIG. 2D, PSU 224 in the second subset is swapped with PSU 226 of the first subset in FIG. 2C. As illustrated in FIG. 2E, PSUs 222 and 223 in the second subset are swapped with PSUs 224 and 225 of the first subset in FIG. 2D, or PSUs 222 and 223 in the second subset are swapped with PSUs 225 and 226 in the first subset in FIG. 2C. As illustrated in FIG. 2F, PSU 221 in the second subset is swapped with PSU 223 the first subset in FIG. 2E, or PSUs 221 and 222 in the second subset are swapped with PSUs 225 and 226 in the first subset in FIG. 2C. As illustrated in FIG. 2G, PSU 226 in the second subset is swapped with PSU 222 the first subset in FIG. 2F, or PSU 221 in the second subset is swapped with PSU 225 in the first subset in FIG. 2C.

It should be understood that the patterns of a first subset and a second subset PSUs in FIGS. 2A-2G are presented solely for illustrative purposes. Actual patterns may vary and include various other types of patterns in accordance with the present technology. For example, the actual patterns can include a predetermined pattern or a pattern dynamically determined based upon a predicted loading of the server system, loading of the two or more PSUs of the server system, or health of each individual PSU.

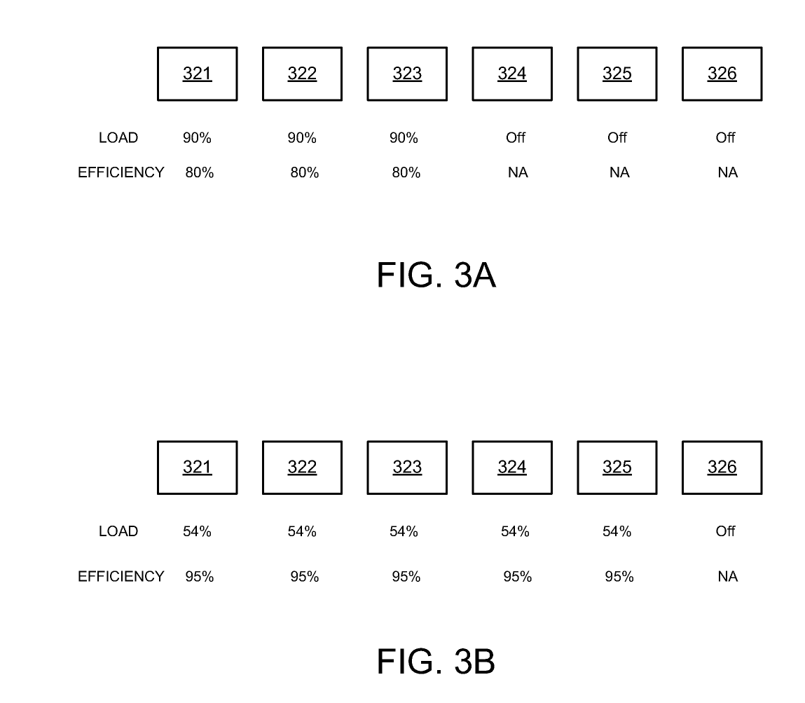

FIGS. 3A-3B illustrate additional examples of a first subset of two or more PSUs that are turned off and a second subset of the two or more PSUs that are in operation in accordance with implementations of the present technology. FIG. 3A illustrates a scenario when some of PSUs in a server system operates in a heavy load condition. In this example, there are a total of six PSUs in the sever system. Each of PSUs 321, 322, and 323 operates with a 90% load and has a lower operating efficiency than operating efficiencies with an optimized load (e.g., 50%). In this example, present and/historical loading of the server system and loading of six PSUs in the server system can be collected and analyzed to predict a loading pattern of the server system and used to determine the first subset and the second subset of the PSUs according to one or more PSU management algorithms. Let's assume that each of six PSUs reaches an optimized efficiency level when a corresponding PSU operates at a 50% load. FIG. 3B illustrates an example of the first subset of PSUs (i.e., 326) that is turned off and the second subset of PSUs (i.e., 321, 322, 323, 324 and 325) that are in operation. In this example, the PSUs 321, 322, 323, 324 and 325 in the second subset operates at a substantially optimized efficiency level (i.e., 54%) while the PSU 326 in the first subset is turned off.

In some implementations, a controller of the server system can compare the loading of PSUs in the server system with a predetermined high threshold value (e.g., 75%). In response to determining that two or more PSUs operate with a load higher than the high threshold value, the controller can turn on one of PSUs in the first subset and include the corresponding PSU in the second subset of PSUs that are in operation.

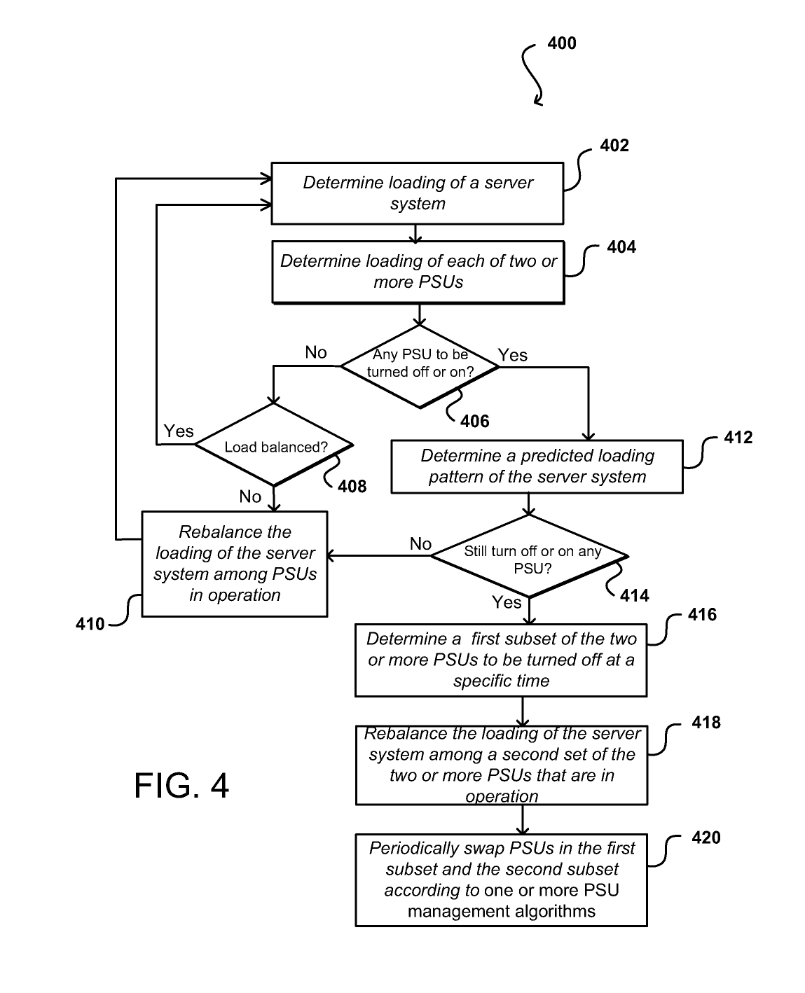

FIG. 4 illustrates an exemplary method of managing power supply units of a server system in accordance with an implementation of the present technology. It should be understood that the exemplary method 400 is presented solely for illustrative purposes and that in other methods in accordance with the present technology can include additional, fewer, or alternative steps performed in similar or alternative orders, or in parallel.

The exemplary method 400 starts with determining loading of a server system, at step 402. Loading of each of two or more PSUs of the server system can also be determined, at step 404. In some implementations, historical loading information of the server system, and/or loading information of other server systems can be collected and analyzed.

At step 406, a determination can be made whether any of the two or more PSUs needs to be turned off or turned on by analyzing the present loading of the server system and the loading of the two or more PSUs according to one or more PSU management algorithms.

In response to determining that one or more PSUs do not need to be turned off or turned on at step 406, a determination can be made whether the loading of the server system is balanced among a second subset of PSUs that are in operation, at step 408. In response to the loading of the server system is not balanced, the loading of the server system can be rebalanced among the second subset of PSUs that are in operation, at step 410. The method can then continue monitoring starting at step 402.

In response to determining that one or more PSUs need to be turned off or turned on at step 406, a predicted loading pattern of the server system can be determined according to the one or more PSU management algorithms, at step 412. In some implementations, the predicted loading pattern of the server system can be determined based at least upon the present and/or historical loading of the server system, or loadings of other server systems. In some implementations, the one or more PSU management algorithms include at least one machine learning algorithm. Collected present and/or historical loading information of the server system and other server systems can be analyzed according to the at least one machine learning algorithm and used to predict the loading pattern of the server system at a specific future time.

Based upon the predicted loading pattern of the server system, a determination can be made whether any PSU needs to be turned on or turned off according to one or more PSU management algorithms, at step 414. In response to determining that no PSU in the second subset needs to be turned off or no PSU in the first subset needs to be turned on, the loading of the server system can be rebalanced among the second subset of PSUs that are in operation, at 410. However, in response to determining that at least one PSU still needs to be turned off or turned on, a first subset of PSUs to be turned off at a specific time can be determined based at least upon the predicted loading pattern of the server system at the corresponding time, at step 416.

At step 418, the loading of the server system can be rebalanced among the second subset of PSUs that are in operation. One or more PSUs in the first subset of PSUs that are turned off and the second subset of PSUs that are in operation can be periodically swapped according to the one or more PSU management algorithms, at step 420. In some implementations, PSUs in the first subset and the second subset are periodically swapped according to a predetermined pattern.

### Terminologies

A computer network is a geographically distributed collection of nodes interconnected by communication links and segments for transporting data between endpoints, such as personal computers and workstations. Many types of networks are available, with the types ranging from local area networks (LANs) and wide area networks (WANs) to overlay and software-defined networks, such as virtual extensible local area networks (VXLANs).

LANs typically connect nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. LANs and WANs can include layer 2 (L2) and/or layer 3 (L3) networks and devices.

The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. Computer networks can be further interconnected by an intermediate network node, such as a router, to extend the effective “size” of each network.

Overlay networks generally allow virtual networks to be created and layered over a physical network infrastructure. Overlay network protocols, such as Virtual Extensible LAN (VXLAN), Network Virtualization using Generic Routing Encapsulation (NVGRE), Network Virtualization Overlays (NVO3), and Stateless Transport Tunneling (STT), provide a traffic encapsulation scheme which allows network traffic to be carried across L2 and L3 networks over a logical tunnel. Such logical tunnels can be originated and terminated through virtual tunnel end points (VTEPs).

Moreover, overlay networks can include virtual segments, such as VXLAN segments in a VXLAN overlay network, which can include virtual L2 and/or L3 overlay networks over which VMs communicate. The virtual segments can be identified through a virtual network identifier (VNI), such as a VXLAN network identifier, which can specifically identify an associated virtual segment or domain.

Network virtualization allows hardware and software resources to be combined in a virtual network. For example, network virtualization can allow multiple numbers of VMs to be attached to the physical network via respective virtual LANs (VLANs). The VMs can be grouped according to their respective VLAN, and can communicate with other VMs as well as other devices on the internal or external network.

Network segments, such as physical or virtual segments, networks, devices, ports, physical or logical links, and/or traffic in general can be grouped into a bridge or flood domain. A bridge domain or flood domain can represent a broadcast domain, such as an L2 broadcast domain. A bridge domain or flood domain can include a single subnet, but can also include multiple subnets. Moreover, a bridge domain can be associated with a bridge domain interface on a network device, such as a switch. A bridge domain interface can be a logical interface which supports traffic between an L2 bridged network and an L3 routed network. In addition, a bridge domain interface can support internet protocol (IP) termination, VPN termination, address resolution handling, MAC addressing, etc. Both bridge domains and bridge domain interfaces can be identified by a same index or identifier.

Furthermore, endpoint groups (EPGs) can be used in a network for mapping applications to the network. In particular, EPGs can use a grouping of application endpoints in a network to apply connectivity and policy to the group of applications. EPGs can act as a container for buckets or collections of applications, or application components, and tiers for implementing forwarding and policy logic. EPGs also allow separation of network policy, security, and forwarding from addressing by instead using logical application boundaries.

Cloud computing can also be provided in one or more networks to provide computing services using shared resources. Cloud computing can generally include Internet-based computing in which computing resources are dynamically provisioned and allocated to client or user computers or other devices on-demand, from a collection of resources available via the network (e.g., “the cloud”). Cloud computing resources, for example, can include any type of resource, such as computing, storage, and network devices, virtual machines (VMs), etc. For instance, resources can include service devices (firewalls, deep packet inspectors, traffic monitors, load balancers, etc.), compute/processing devices (servers, CPU's, memory, brute force processing capability), storage devices (e.g., network attached storages, storage area network devices), etc. In addition, such resources can be used to support virtual networks, virtual machines (VM), databases, applications (Apps), etc.

Cloud computing resources can include a “private cloud,” a “public cloud,” and/or a “hybrid cloud.” A “hybrid cloud” can be a cloud infrastructure composed of two or more clouds that inter-operate or federate through technology. In essence, a hybrid cloud is an interaction between private and public clouds where a private cloud joins a public cloud and utilizes public cloud resources in a secure and scalable manner. Cloud computing resources can also be provisioned via virtual networks in an overlay network, such as a VXLAN.

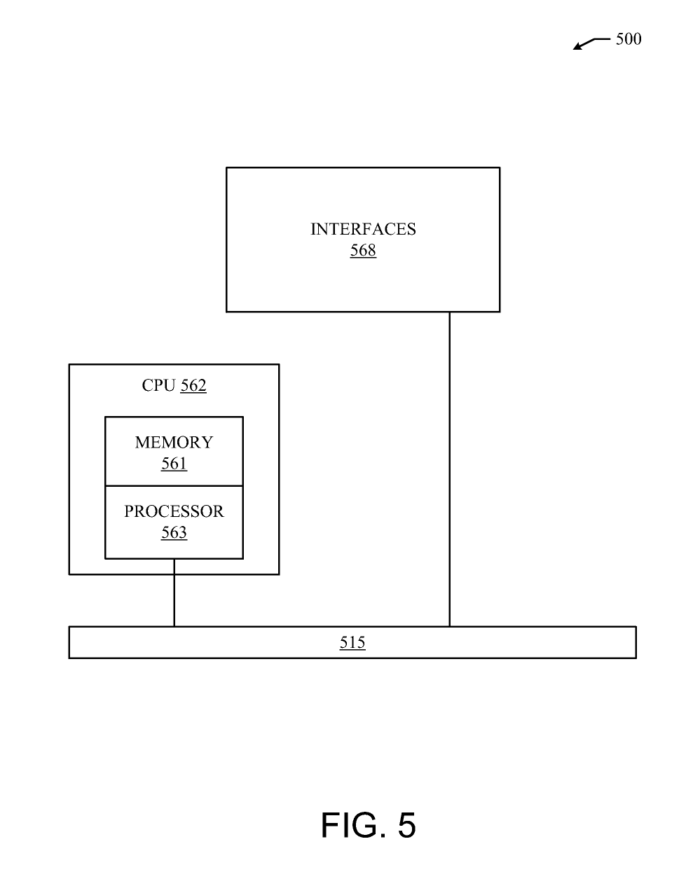

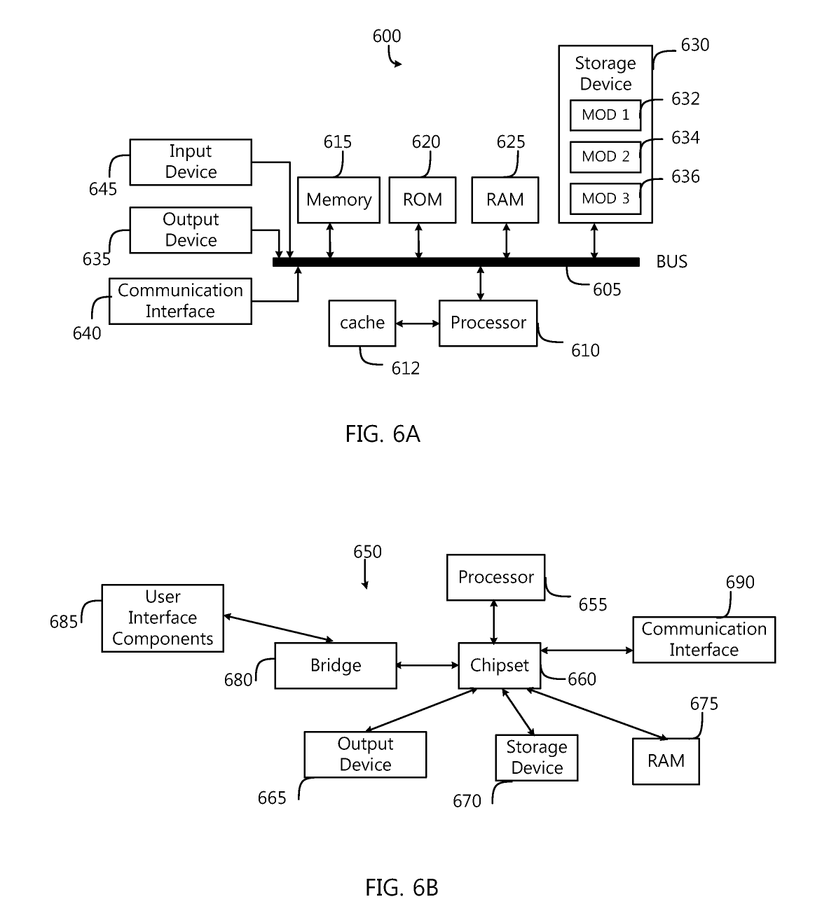

In a network server system, a lookup database can be maintained to keep track of routes between a number of end points attached to the server system. However, end points can have various configurations and are associated with numerous tenants. These end-points can have various types of identifiers, e.g., IPv4, IPv6, or Layer-2. The lookup database has to be configured in different modes to handle different types of end-point identifiers. Some capacity of the lookup database is carved out to deal with different address types of incoming packets. Further, the lookup database on the network server system is typically limited by 1K virtual routing and forwarding (VRFs). Therefore, an improved lookup algorithm is desired to handle various types of end-point identifiers. The disclosed technology addresses the need in the art for address lookups in a telecommunications network. Disclosed are systems, methods, and computer-readable storage media for unifying various types of end-point identifiers by mapping end-point identifiers to a uniform space and allowing different forms of lookups to be uniformly handled. A brief introductory description of example systems and networks, as illustrated in FIGS. 5 and 6, is disclosed herein. These variations shall be described herein as the various examples are set forth. The technology now turns to FIG. 5.

FIG. 5 illustrates an example computing device 500 suitable for implementing the present technology. Computing device 500 includes a master central processing unit (CPU) 562, interfaces 568, and a bus 515 (e.g., a PCI bus). When acting under the control of appropriate software or firmware, the CPU 562 is responsible for executing packet management, error detection, and/or routing functions, such as miscabling detection functions, for example. The CPU 562 preferably accomplishes all these functions under the control of software including an operating system and any appropriate applications software. CPU 562 can include one or more processors 563 such as a processor from the Motorola family of microprocessors or the MIPS family of microprocessors. In an alternative embodiment, processor 563 is specially designed hardware for controlling the operations of the computing device 500. In a specific embodiment, a memory 561 (such as non-volatile RAM and/or ROM) also forms part of CPU 562. However, there are many different ways in which memory could be coupled to the system.

The interfaces 568 are typically provided as interface cards (sometimes referred to as “line cards”). Generally, they control the sending and receiving of data packets over the network and sometimes support other peripherals used with the computing device 500. Among the interfaces that can be provided are Ethernet interfaces, frame relay interfaces, cable interfaces, DSL interfaces, token ring interfaces, and the like. In addition, various very high-speed interfaces can be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces can include ports appropriate for communication with the appropriate media. In some cases, they can also include an independent processor and, in some instances, volatile RAM. The independent processors can control such communications intensive tasks as packet switching, media control and management. By providing separate processors for the communications intensive tasks, these interfaces allow the master microprocessor 562 to efficiently perform routing computations, network diagnostics, security functions, etc.

Although the system shown in FIG. 5 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it can employ one or more memories or memory modules (including memory 561) configured to store program instructions for the general-purpose network operations and mechanisms for roaming, route optimization and routing functions described herein. The program instructions can control the operation of an operating system and/or one or more applications, for example. The memory or memories can also be configured to store tables such as mobility binding, registration, and association tables, etc.

FIG. 6A, and FIG. 6B illustrate example possible systems in accordance with various aspects of the present technology. The more appropriate embodiment will be apparent to those of ordinary skill in the art when practicing the present technology. Persons of ordinary skill in the art will also readily appreciate that other system examples are possible.

FIG. 6A illustrates a conventional system bus computing system architecture 600 wherein the components of the system are in electrical communication with each other using a bus 605. Example system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 can be available for use as well. The memory 615 can include multiple different types of memory with different performance characteristics. The processor 610 can include any general purpose processor and a hardware module or software module, such as module 632, module 634, and module 636 stored in storage device 630, configured to control the processor 610 as well as a special-purpose processor where software instructions are incorporated into the actual processor design. The processor 610 can essentially be a completely self-contained computing system, containing multiple cores or processors, a bus, memory controller, cache, etc. A multi-core processor can be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here can easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, output device 635 (e.g., a display), and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or RAM 675. Further, the machine can receive inputs from a user via user interface components 685 and execute appropriate functions, such as browsing functions by interpreting these inputs using processor 655.

It can be appreciated that example systems 600 and 650 can have more than one processor 610 or be part of a group or cluster of computing devices networked together to provide greater processing capability.

For clarity of explanation, in some instances the present technology can be presented as including individual functional blocks including functional blocks comprising devices, device components, steps or routines in a method embodied in software, or combinations of hardware and software.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Various aspects of the present technology provide methods for managing two or more PSUs in a server system to achieve substantially optimized power efficiency and MTBFs of PSUs. While specific examples have been cited above showing how the optional operation can be employed in different instructions, other examples can incorporate the optional operation into different instructions. For clarity of explanation, in some instances the present technology can be presented as including individual functional blocks including functional blocks comprising devices, device components, steps or routines in a method embodied in software, or combinations of hardware and software.

The various examples can be further implemented in a wide variety of operating environments, which in some cases can include one or more server computers, user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

To the extent examples, or portions thereof, are implemented in hardware, the present invention can be implemented with any or a combination of the following technologies: a discrete logic circuit(s) having logic gates for implementing logic functions upon data signals, an application specific integrated circuit (ASIC) having appropriate combinational logic gates, programmable hardware such as a programmable gate array(s) (PGA), a field programmable gate array (FPGA), etc.

Most examples utilize at least one network that would be familiar to those skilled in the art for supporting communications using any of a variety of commercially-available protocols, such as TCP/IP, OSI, FTP, UPnP, NFS, CIFS, AppleTalk etc. The network can be, for example, a local area network, a wide-area network, a virtual private network, the Internet, an intranet, an extranet, a public switched telephone network, an infrared network, a wireless network and any combination thereof.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, flash memory, USB devices provided with non-volatile memory, networked storage devices, and so on.

Devices implementing methods according to these technology can comprise hardware, firmware and/or software, and can take any of a variety of form factors. Typical examples of such form factors include server computers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

In examples utilizing a Web server, the Web server can run any of a variety of server or mid-tier applications, including HTTP servers, FTP servers, CGI servers, data servers, Java servers and business application servers. The server(s) can also be capable of executing programs or scripts in response requests from user devices, such as by executing one or more Web applications that can be implemented as one or more scripts or programs written in any programming language, such as Java®, C, C# or C++ or any scripting language, such as Perl, Python or TCL, as well as combinations thereof. The server(s) can also include database servers, including without limitation those commercially available from open market.

The server farm can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system can also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared computing device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate examples can have numerous variations from that described above. For example, customized hardware might also be used and/or particular elements might be implemented in hardware, software (including portable software, such as applets) or both. Further, connection to other computing devices such as network input/output devices can be employed.

Storage media and computer readable media for containing code, or portions of code, can include any appropriate media known or used in the art, including storage media and computing media, such as but not limited to volatile and non-volatile, removable and non-removable media implemented in any method or technology for storage and/or transmission of information such as computer readable instructions, data structures, program modules or other data, including RAM, ROM, EPROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the technology and teachings provided herein, a person of ordinary skill in the art will appreciate other ways and/or methods to implement the various aspects of the present technology.

The specification and drawings are, accordingly, to be regarded in an illustrative rather than a restrictive sense. It will, however, be evident that various modifications and changes can be made thereunto without departing from the broader spirit and scope of the invention as set forth in the claims.

What is claimed is:

1. A server system, comprising:
at least one processor; and
memory including instructions that, when executed by the at least one processor, cause the system to:
collect loading of the server system;
collect loading of each of two or more power supply units (PSUs) of the server system;
determine a first subset of the two or more PSUs to be turned off based at least upon the loading of the server system and the loading of the two or more PSUs according to one or more PSU management algorithms; and
cause one or more PSUs in the first subset to be periodically swapped with one or more PSUs in a second subset of the two or more PSUs that are in operation according to the one or more PSU management algorithms.

2. The system of claim 1, wherein the instructions when executed further cause the system to:
collect historical loading information of the server system;
determine a predicted loading pattern at a specific time based at least upon the historical loading of the server system according to the one or more PSU management algorithms; and
determine the first subset of the two or more PSUs to be turned off at the specific time.

3. The system of claim 2, wherein the instructions when executed further cause the system to:
collect loading information of other server systems; and
determine the predicted loading pattern at the specific time based at least upon the loading information of the other server systems according to the one or more PSU management algorithms.

4. The system of claim 3, wherein the instructions when executed further cause the system to:
collect information associated with the server system including time of day, day of a year, temperature, cooling fan speeds, power status, memory and operating system (OS) status, various data packet arrival rates, and data queue statistics; and
determine the predicted loading pattern at the specific time according to the one or more PSU management algorithms based at least upon a portion of collected information associated with the server system.

5. The system of claim 1, wherein the one or more PSU management algorithms include at least one of machine learning algorithm.

6. The system of claim 5, wherein the at least one of machine learning algorithm includes linear regression model, neural network model, support vector machine based model, Bayesian statistics, case-based reasoning, decision trees, inductive logic programming, Gaussian process regression, group method of data handling, learning automata, random forests, ensembles of classifiers, ordinal classification, or conditional random field.

7. The system of claim 1, wherein the instructions when executed further cause the system to:
balance the loading of the server system among PSUs in the second subset of the two or more PSUs of the server system.

8. The system of claim 7, wherein the second subset of the two or more PSUs has at least one PSU that operates above a threshold efficiency level.

9. The system of claim 1, wherein the instructions when executed further cause the system to:
cause the one or more PSUs in the first subset and the second subset to be periodically swapped with a predetermined pattern such that mean time between failures (MTBFs) of the two or more PSUs are substantially optimized.

10. The system of claim 1, wherein the instructions when executed further cause the system to:
compare loading of each PSU in the second subset with a predetermined low threshold value;
in response to determining that at least two PSUs in the second subset operate with loading levels lower than the predetermined low threshold value, cause one of the at least two PSUs to be turned off and assigned to the first subset of the two or more PSUs.

11. The system of claim 1, wherein the instructions when executed further cause the system to:
compare loading of each PSU in the second subset with a predetermined high threshold value;
in response to determining that at least two PSUs in the second subset operate with loading levels higher than the predetermined high threshold value, cause one PSU in the first subset to be turned on and assigned to the second subset of the two or more PSUs.

12. A computer-implemented method for managing two or more power supply units (PSUs) in a server system, comprising:
collecting loading of the server system;
collecting loading of each of two or more PSUs of the server system;
determining a first subset of the two or more PSUs to be turned off based at least upon the loading of the server system and the loading of the two or more PSUs according to one or more PSU management algorithms; and
causing one or more PSUs in the first subset to be periodically swapped with one or more PSUs in a second subset of the two or more PSUs that are in operation according to the one or more PSU management algorithms.

13. The computer-implemented method of claim 12, further comprising:
collecting historical loading information of the server system;
determining a predicted loading pattern at a specific time based at least upon the historical loading of the server system according to the one or more PSU management algorithms; and
determining the first subset of the two or more PSUs to be turned off at the specific time.

14. The computer-implemented method of claim 13, further comprising:
collecting information associated with the server system including time of day, day of a year, temperature, cooling fan speeds, power status, memory and operating system (OS) status, various data packet arrival rates, and data queue statistics; and
determining the predicted loading pattern at the specific time according to the one or more PSU management algorithms based at least upon a portion of collected information associated with the server system.

15. The computer-implemented method of claim 12, further comprising:
comparing loading of each PSU in the second subset with a predetermined high threshold value;
in response to determining that at least two PSUs in the second subset operate with loading levels higher than the predetermined high threshold value, causing one PSU in the first subset to be turned on and assigned to the second subset of the two or more PSUs.

16. The computer-implemented method of claim 12, wherein the one or more PSU management algorithms include at least one of machine learning algorithm, the at least one of machine learning algorithm including linear regression model, neural network model, support vector machine based model, Bayesian statistics, case-based reasoning, decision trees, inductive logic programming, Gaussian process regression, group method of data handling, learning automata, random forests, ensembles of classifiers, ordinal classification, or conditional random field.

17. The computer-implemented method of claim 12, further comprising:
balancing the loading of the server system among PSUs in the second subset of the two or more PSUs of the server system;
wherein the second subset of the two or more PSUs has at least one PSU that operates above a threshold efficiency level.

18. A non-transitory computer-readable storage medium including instructions that, when executed by at least one processor of a server system, cause the server system to:
collect loading of the server system;
collect loading of each of two or more PSUs of the server system;
determine a first subset of the two or more PSUs to be turned off based at least upon the loading of the server system and the loading of the two or more PSUs according to one or more PSU management algorithms; and
cause one or more PSUs in the first subset to be periodically swapped with one or more PSUs in a second subset of the two or more PSUs that are in operation according to the one or more PSU management algorithms.

19. The non-transitory computer-readable storage medium of claim 18, wherein the instructions when executed further cause the system to:
cause the one or more PSUs in the first subset and the second subset to be periodically swapped with a predetermined pattern such that mean time between failures (MTBFs) of the two or more PSUs are substantially optimized.

20. The non-transitory computer-readable storage medium of claim 18, wherein the instructions when executed further cause the system to:
compare loading of each PSU in the second subset with a predetermined low threshold value;
in response to determining that at least two PSUs in the second subset operate with loading levels lower than the predetermined low threshold value, cause one of the at least two PSUs to be turned off and assigned to the first subset of the two or more PSUs.
